(19) United States
(12) Patent Application Publication
(10) Pub. No.: US 2026/0063281 A1
(43) Pub. Date: Mar. 5, 2026

(54) FASTENING DEVICE FOR A LIGHTING UNIT AND LIGHTING UNIT

(71) Applicant: Arnold & Richter Cine Technik GmbH & Co. Betriebs KG, München (DE)

(72) Inventor: Andre Reuter, Rosenheim (DE)

(21) Appl. No.: 19/318,462

(22) Filed: Sep. 4, 2025

(30) Foreign Application Priority Data
Sep. 5, 2024 (DE) 202024105085.1

(51) Int. Cl. F21V 21/03; F21V 21/008

(52) U.S. Cl. CPC F21V 21/03; F21V 21/008

(57) ABSTRACT

A fastening device for a lighting unit, the fastening device being configured to fasten a suspension for suspending the lighting unit. The fastening device includes a main body which can be arranged on the lighting unit and which includes at least one recess for receiving the suspension, the recess being formed on an outer side of the main body, and at least one fastening member which is arranged on the outer side of the main body corresponding to the at least one recess so that the suspension is held by the fastening member.

### FIELD OF INVENTION

The present disclosure relates to a fastening device for a lighting unit and a lighting unit.

### TECHNICAL BACKGROUND

There are known lighting units for illumination purposes, which are used, for example, in television, studio, or theater productions, wherein such lighting units are fastened or suspended on corresponding devices, for example, holders, frames, tripods, or ceiling constructions, in order to achieve optimum illumination, to produce certain lighting effects, or the like.

For this purpose, the lighting units often comprise special fastening devices by means of which the lighting units can, for example, be suspended and secured against falling down, wherein different fastening members, accessories or tools are usually required, which involve complicated handling for a user.

In this respect, end face suspensions or securing devices are particularly difficult to design, since they usually require an eye screw or other protruding elements to ensure suspension or securing.

### SUMMARY OF THE INVENTION

Against this background, it is one of the ideas of the present disclosure to provide a fastening device for a lighting unit and a lighting unit which enables easy handling and flexible use and is inexpensive and easy to manufacture.

Furthermore, it is advantageous to achieve an end face suspension or securing device that requires little installation space.

Accordingly, the present disclosure provides:
A fastening device for a lighting unit, wherein the fastening device is configured to fasten a suspension for fastening the lighting unit, comprising a main body which can be arranged on the lighting unit and comprises at least one recess for receiving the suspension, wherein the recess is formed on an outer side of the main body, and at least one fastening member which is arranged on the outer side of the main body corresponding to the at least one recess, so that the suspension is held by the fastening member.
A lighting unit comprising at least one lighting housing and at least one fastening device according to the embodiment described above, wherein the fastening device is arranged or can be arranged on an end face of the lighting housing.

An aspect of the present disclosure is to provide a user with easy handling and a flexible way of suspending a lighting unit by means of the fastening device. For this purpose, the fastening device comprises at least one fastening member arranged in correspondence with the recess, to which the user can easily attach the suspension in order to suspend and/or secure the lighting unit. The suspension can preferably be a rope, a cord, a cable, a wire rope, a cable tie or any other essentially flexible element suitable for suspending the lighting unit.

Alternatively, or additionally, the suspension can be configured as a securing member or form a securing device. Such a suspension configured as a securing member or securing device can be provided, for example, to secure the lighting unit from falling in the event another fastening device for attaching or suspending the lighting unit fails.

The lighting units are configured, for example, as elongated lights. Other forms of lighting units are also conceivable. For example, the lighting units can be configured as LED lighting means, halogen lighting means, fluorescent lamps or the like.

According to some embodiments, the main body can be arranged on an end face of the lighting unit and/or form an end face of the lighting unit and the at least one fastening member can be positioned on the main body, at the end face. In some implementations, the at least one fastening member can be positioned at the end face in a center of gravity axis of the lighting unit on the main body. The center of gravity axis of the lighting unit preferably runs along a longitudinal extension of the lighting unit. By positioning the at least one fastening member on the end face and/or in the center of gravity axis of the lighting unit, the lighting unit can be hung vertically aligned on the suspension. This eliminates the need to align the lighting unit during suspension, allowing a user to attach the suspension to the lighting unit quickly and easily.

According to some embodiments, the at least one fastening member can be detachably attached to the main body or be formed integrally with the main body. In particular, the fastening member forms a flush or flat end face, i.e., a flush or flat end of the lighting unit. As a result, a compact configuration of the fastening device can be formed without interfering protrusions or projections, which can save installation space and improve the visual appearance.

According to some embodiments, the at least one fastening member may comprise at least one passage as access to the recess and at least one further passage as exit from the recess, wherein a fastening portion for fastening the suspension is formed between the passages. Because the fastening portion is provided between the passages arranged at a distance from one another, the fastening portion can form, for example, a web-shaped portion of the fastening member around which the suspension for suspending the lighting unit can be guided. This makes it easy to attach the suspension to the fastening portion.

According to some embodiments, the at least one fastening member can be formed by an end plate, which is arranged on the end face of the main body. In some implementations, the end plate can be screwed onto the end face of the main body and thus be detachably connected to the main body. Alternatively, or additionally, it may be provided that the end plate can be attached to the main body by a snap-in connection or that the end plate is non-detachably attached to the main body, for example by a positive connection, a welded connection, a soldered connection, an adhesive connection or the like. The end plate may in some implementations be configured as a flat, plate-shaped element. In some implementations, the end plate covers the end face of the main body in portions or completely and/or forms a flat end face of the lighting unit.

According to some embodiments, the suspension can be guided through the recess in such a manner that a deflection of the suspension by at least 90° is possible. In particular, it may be possible to deflect the suspension by at least 90° to 180° through the recess. By the recess forming a guide for the suspension, through which the suspension can be deflected by at least 90°, simple fastening of the suspension to the fastening member is achieved. The user can insert the suspension into the recess at the end face, wherein the suspension is deflected by at least 90° within the recess so that it can be automatically guided out of the recess again at the end face. In particular, such fastening of the suspension can be carried out by the user without tools, for example also by fastening the suspension to the fastening member with one hand, which can provide particularly easy handling for the user.

According to some embodiments, the recess can comprise an inner contour acting as a deflection, which is configured in such a manner that a suspension, which can be inserted into the recess, is at least partially flexible, can be deflected by the inner contour and can be guided out of the recess again. In particular, the inner contour of the recess is configured in such a manner that the suspension is deflected by the inner contour in such a manner that the suspension is guided around the, for example, web-shaped fastening portion. As a result, the suspension, which may be one of a rope, a cord, a cable, a wire rope, a cable tie and the like, as already described above, can be fastened to the fastening portion by the user in a simple manner without the need for cumbersome manual threading or the like of the suspension on the fastening member.

According to some embodiments, the inner contour of the recess acting as a deflection may comprise at least one insertion bevel associated with the at least one passage and at least one extraction bevel associated with the at least one further passage. In some implementations, the insertion bevel and/or the extraction bevel can be inclined at an angle of inclination which is formed with respect to a bottom portion of the recess in an angle range of at most 80°, for example at most 70°, and for example at most 60°, and/or at least 10°, for example at least 20°, and for example at least 30°. By inclining the insertion bevel and/or the extraction bevel with respect to the bottom portion of the recess at such an angle of inclination, optimum guidance and deflection of the suspension by at least 90° can be achieved. In particular, this can ensure that the essentially flexible suspension does not buckle within the recess and thereby block the recess.

According to an advantageous embodiment, the recess can form a V-shaped or U-shaped inner contour in cross-section, at least in portions, and/or the recess comprises a flat and/or curved bottom portion. Such a V-shaped or U-shaped inner contour of the recess can be used to achieve a secure deflection of the suspension without buckling occurring when the suspension is deflected. However, the inner contour of the recess is not limited to such a V-shaped or U-shaped inner contour, but can rather comprise any configuration that enables safe deflection of the suspension within the recess. For example, the recess can also comprise a partially spherical, parabolic or similar inner contour.

According to an advantageous embodiment, provision can be made on the main body for a coupling device for a securing member and/or a securing member can be arranged on the main body. Preferably, the coupling device can be provided on the end face of the main body. Such a coupling device can be configured in particular to fasten an additional safety device to the lighting unit in addition to the suspension, so that the lighting unit is protected from falling in the event of a failure of the suspension. The coupling device can, for example, be formed by a threaded hole in the main body into which the securing member, for example an eyebolt, eyelet, hook or the like, is screwed in order to be able to attach the securing device to it. Alternatively, or additionally, the coupling device can also be designed for attaching a suspension for hanging the lighting unit.

The same features and advantages as described for the fastening device also apply to the lighting unit.

The above embodiments and modifications may be combined with each other in any sensible way. Other possible embodiments, developments and implementations include combinations of features of the embodiments described above or below with respect to the exemplary embodiments, which combinations are not explicitly mentioned. In this respect, the skilled person will in particular also add individual aspects as improvements or additions to the respective basic form of the present disclosure.

### BRIEF SUMMARY OF THE DRAWINGS

Aspects of the present disclosure are explained in more detail below with reference to the exemplary embodiments given in the schematic figures of the drawings. The figures show:

FIG. 1 a perspective view of a lighting unit with a fastening device according to an embodiment;

FIG. 2 a perspective sectional view of the fastening device for the lighting unit;

FIG. 3 a sectional view of the fastening device on a suspension;

FIG. 4 a perspective sectional view of the fastening device in FIG. 3.

The accompanying figures are intended to provide a further understanding of the embodiments of this disclosure. They illustrate embodiments and, in connection with the description, serve to explain principles and concepts of the disclosure. Further embodiments and many of the advantages mentioned result with regard to the drawings. The elements of the drawings are not necessarily shown to scale in relation to one another.

In the figures of the drawing, identical elements, features, and components that have the same function and effect-unless stated otherwise-are each provided with the same reference signs.

### DESCRIPTION OF SOME EXEMPLARY EMBODIMENTS

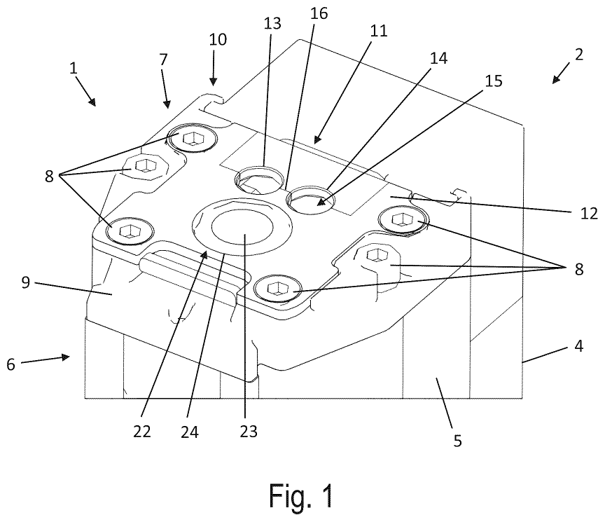

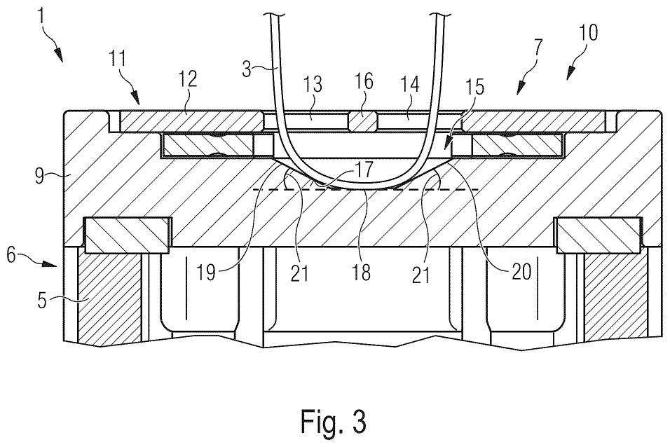

FIG. 1 shows a perspective view of an embodiment of a fastening device 1 for a lighting unit 2 according to the present disclosure. This fastening device 1 is provided for fastening a suspension 3 (see FIG. 3), described in more detail below, to the fastening device 1. By fastening the suspension 3 to the fastening device 1, the lighting unit 2 can be suspended, for example from a bracket, a stand, a tripod, a ceiling structure or the like. Furthermore, the suspension can also be used to secure the lighting unit 2.

The lighting unit 2 is in particular a lamp that is used for lighting purposes in television, studio or theater productions, for which purpose it comprises one or more lighting means 4. The lighting means 4 is not limited to a specific light source and can, for example, be an LED light source, a halogen light source, a fluorescent lamp or the like.

In this exemplary embodiment, the lighting unit 2 comprises a lighting housing 5 for accommodating the one or more lighting means 4, wherein the lighting unit 2, in particular the lighting housing 5, comprises an elongated basic shape. The elongated lighting housing 5 forms opposite end portions 6, on each of which an end face 7 is formed.

In this exemplary embodiment, the fastening device 1 is attached to the end face 7 of the lighting housing 5, wherein the fastening device 1 is screwed to the end face 7 of the lighting housing 5 by a plurality of screw members 8. In an alternative embodiment of the lighting unit 2, which is not shown, the fastening device 1 can also be integral with the lighting housing 5 or a component of the lighting housing 5 or attached to the lighting housing 5 by another connection.

In this exemplary embodiment, the fastening device 1 comprises a main body 9, which is screwed to the end face 7 of the lighting housing 5 by the screw members 8. In particular, the main body 9 is made of a metallic material, for example aluminum, steel or the like. The main body 9 can be produced by any manufacturing process, for example by a casting process, molding process, milling process or the like.

In this exemplary embodiment, a fastening member 11 is arranged on an end face outer side 10 of the main body 9, by means of which the suspension 3 for suspending the lighting unit 2 is held. The fastening member 11 is formed by an end plate 12, which is screwed to the end face of the main body 9 by several screw members 8. The fastening member 11 is thus detachably attached to the main body 9. Alternatively, the fastening member 11 can also be formed integrally with the main body 9. In particular, the end plate 12 forms a flush and/or flat end surface of the lighting unit 2.

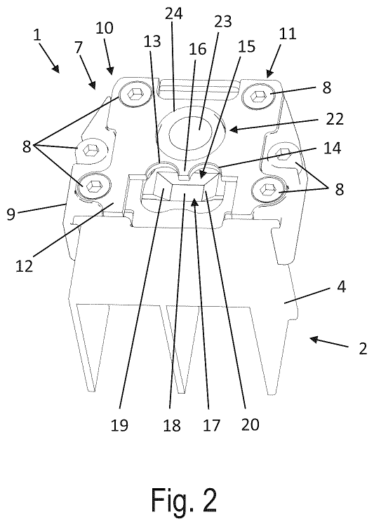

On the fastening member 11 in this exemplary embodiment, provision is made for two passages 13, 14 which are configured separately from one another and which form access to a recess 15 in the main body 9 as shown in FIG. 2. The passages 13, 14 are formed, for example, as adjacent bores in the fastening member 11. By arranging the passages 13, 14 directly adjacent to one another in the fastening member 11, a fastening portion 16 is formed between the passages 13, 14, to which the suspension 3 can be fastened. In particular, the fastening portion 16 forms a web-shaped portion of the fastening member 11, which is formed between the passages 13, 14. For fastening the suspension 3, it is inserted into one of the two passages 13, 14 and guided out of the other of the two passages 13, 14 again, so that the suspension 3 is guided around the web-shaped fastening portion 16 formed between the passages 13, 14.

In order to be able to guide the suspension 3 around the fastening portion 16, the recess 15 is formed in the main body 9 corresponding to the two passages 13, 14, as shown by way of example in FIG. 2. Consequently, in this embodiment, one of the two passages 13, 14 forms an access to the recess 15 and the other of the two passages 13, 14 forms an exit from the recess 15. As a result, the suspension 3 can be inserted into the recess 15 through one of the two passages 13, 14 and can be guided out of the recess 15 again through the other of the two passages 13, 14 in order to guide the suspension 3 around the fastening portion 16 of the fastening member 11 and fasten it thereto.

In this exemplary embodiment, the fastening member 11, in particular the fastening portion 16, and/or the recess 15 are positioned on the end face 7 of the lighting housing 5 in such a manner that they are aligned with respect to a center of gravity axis formed by the lighting unit 2. The center of gravity axis extends in particular with respect to a longitudinal extension of the lighting unit 2. In this manner, the suspension 3 is aligned with respect to a center of gravity of the lighting unit 2, so that the lighting unit 2 can be suspended from the suspension 3 in a vertical orientation.

In order to guide the suspension 3 around the fastening portion 16, the recess 15 comprises an inner contour 17 acting as a deflection in this exemplary embodiment. So that the suspension 3 can be deflected by the inner contour 17 acting as a deflection, the suspension 3 is configured as an essentially flexible element, in particular as a rope, a cord, a string, a wire rope, a cable tie or the like. In this manner, the flexible suspension 3 can be inserted into the recess 15 and deflected at the inner contour 17 in order to be guided out of the recess 15 again, so that the suspension 3 is subsequently guided around the web-shaped fastening portion 16. The inner contour 17 acting as a deflection thus forms a guide for the suspension 3 inserted into the recess 15.

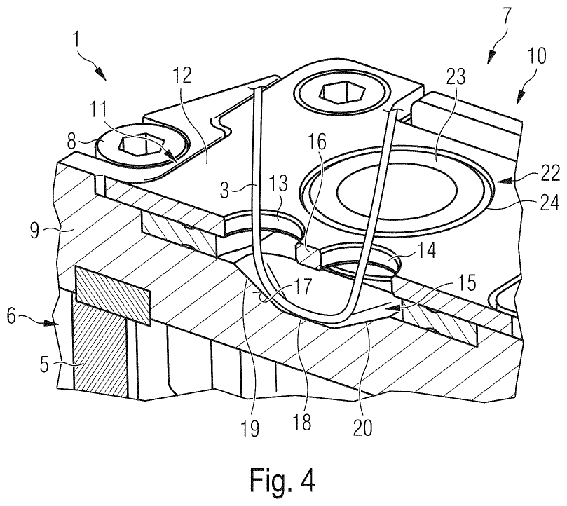

For this purpose, the recess 15 in this exemplary embodiment comprises an inner contour 17 which is V-shaped in cross-section, at least in portions, wherein a bottom portion 18 of the recess 15 is flat, as can be seen in FIGS. 3 and 4. Alternatively or additionally, the recess 15 can also be configured in such a manner that it comprises a U-shaped inner contour 17 and/or a curved bottom portion 18.

Moreover, FIGS. 3 and 4 illustrate how the suspension 3, i.e., the rope, string, cord, wire rope, cable tie or similar, can be deflected by the inner contour 17 of the recess 15 acting as a deflection and guided around the fastening portion 16.

For deflection of the suspension 3, the inner contour 17 of the recess 15 in this exemplary embodiment comprises an insertion bevel 19, which is associated with one of the two passages 13, and an extraction bevel 20, which is associated with the other of the two passages 14. It is understood that, depending on the direction of insertion of the suspension 3, the insertion bevel 19 can also act as an extraction bevel and the extraction bevel 20 can also act as an insertion bevel. Preferably, the insertion bevel 19 and the extraction bevel 20 can be symmetrical to each other. In other words, the recess 15 can have a mirror-symmetrical cross-section.

With respect to the bottom portion 18 of the recess 15, the insertion bevel 19 and the extraction bevel 20 are inclined in this exemplary embodiment at an angle of inclination 21 which is formed in an angle range of at most 80°, preferably at most 70°, further preferably at most 60°, and/or at least 10°, preferably at least 20°, further preferably at least 30°. By inclining the insertion bevel 19 and the extraction bevel 20 in such a range of angles of inclination, the suspension 3 is guided and deflected on the inner contour 17 of the recess 15 in such a manner that a deflection of the suspension 3 by at least 90°, in particular by 90° to 180°, is provided, as shown in FIGS. 3 and 4.

Alternatively, the inner contour 17 of the recess 15 may comprise any other geometry that is suitable for deflecting the flexible suspension 3 in the manner described above. For example, the recess 15 may also comprise a partially spherical or parabolic inner contour 17.

In this exemplary embodiment, a coupling device 22 for a securing member is also provided on the main body 9 on the end side, not illustrated in detail. The coupling device 22 comprises an end face bore 23, in particular a threaded bore, which is formed in the main body 9. The fastening member 11 comprises an aperture 24 corresponding to the bore 23, so that the securing member can be inserted, in particular screwed, through the aperture 24 into the end face of the bore 23. The securing member is preferably an eyebolt, an eyelet, a hook or the like. In addition, the coupling device 22 may alternatively or additionally be provided in order to fasten the previously described suspension 3 thereto. In this case, the fastening member 11 may be provided in order to fasten the securing device thereto.

1. A fastening device for a lighting unit, the fastening device being configured to fasten a suspension for suspending the lighting unit, and comprising:
a main body which can be arranged on the lighting unit and which includes at least one recess for receiving the suspension, the recess being formed on an outer side of the main body; and
at least one fastening member which is arranged on the outer side of the main body corresponding to the at least one recess so that the suspension is held by the fastening member.

2. The fastening device of claim 1, wherein the main body can be arranged on an end face of the lighting unit and/or forms an end face of the lighting unit and the at least one fastening member is positioned on the end face of the main body.

3. The fastening device according to claim 1, wherein the at least one fastening member is detachably attached to the main body or is formed integrally with the main body.

4. The fastening device of claim 1, wherein the at least one fastening member comprises at least one first passage as access to the recess and at least one second passage as exit from the recess.

5. The fastening device of claim 4, wherein a fastening portion for fastening the suspension is formed between the at least one first and the at least one second passage.

6. The fastening device of claim 1, wherein the at least one fastening member is formed by an end plate which is arranged on the end face of the main body.

7. The fastening device of claim 1, wherein the suspension can be guided through the recess in such a manner that a deflection of the suspension by at least 90° is possible.

8. The fastening device of claim 7, wherein a deflection of the suspension by at most 180° is possible.

9. The fastening device of claim 1, wherein the recess comprises an inner contour acting as a deflection, which is configured such that a suspension, which can be inserted into the recess and is flexible at least in portions, can be deflected at the inner contour and can be guided out of the recess again.

10. The fastening device of claim 4, wherein the inner contour of the recess acting as a deflection comprises at least one insertion bevel associated with the at least one passage and which comprises at least one extraction bevel associated with the at least one further passage.

11. The fastening device of claim 10, wherein the recess forms a V-shaped or U-shaped inner contour in cross-section, at least in portions.

12. The fastening device of claim 10, wherein the recess includes a flat or curved bottom portion.

13. The fastening device of claim 1, wherein a coupling device for a securing member is arranged at the end face of the main body.

14. The fastening device of claim 1, wherein a securing member is arranged on the main body.

15. The fastening device of claim 2, wherein the at least one fastening member is positioned on the end face of the main body in a center of gravity axis of the lighting unit.

16. A lighting unit, comprising:
at least one lighting housing; and
at least one fastening device arranged on an end face of the lighting housing,
the at least one fastening device being configured to fasten a suspension for suspending the lighting unit, and including:
a main body arranged on the lighting unit which includes at least one recess for receiving the suspension, the recess being formed on an outer side of the main body; and
at least one fastening member which is arranged on the outer side of the main body corresponding to the at least one recess so that the suspension is held by the fastening member.
